(19) United States
(12) Patent Application Publication
(10) Pub. No.: US 2008/0279494 A1
(43) Pub. Date: Nov. 13, 2008

(54) Bearing cage with oblong cavities and radial angular-contact ball bearing comprising such a cage

(76) Inventor: Jean-Michel Beauprez, Clermont (FR)

Correspondence Address: ARENT FOX LLP, 1050 CONNECTICUT AVENUE, N.W., SUITE 400, WASHINGTON, DC, 20036, US

(21) Appl. No.: 11/979,727

(22) Filed: Nov. 7, 2007

(30) Foreign Application Priority Data
Nov. 22, 2006 (FR) 0610227

(51) Int. Cl. F16C 33/58; F16C 33/38

(52) U.S. Cl. 384/513; 384/526

(57) ABSTRACT

A radial angular-contact ball bearing comprises two annular raceways with balls 24 placed between them, the centres of which are distributed around a pitch circle of the bearing, the points of contact between the balls and the two raceways being distributed on a contact cone. A cage holds the balls and comprises a plurality of cavities 32 for housing the balls. Each cavity comprises two opposing concave walls 36A, 36B forming spherical caps with a radius R, the centres 40A, 40B of the two caps being in the same radial plane at a distance from one another along an axis 42 that is tilted in relation to the axis of rotation of the bearing. The oblong shape of the cavities reduces the friction between them and the balls.

### TECHNICAL FIELD OF THE INVENTION

The invention relates to a cage for a radial angular-contact ball bearing and to a bearing comprising such a cage.

### PRIOR ART

Radial angular-contact ball bearings such as, in particular, bump stop bearings, are generally equipped with a polyamide cage with cavities for holding the balls. These cavities have walls in the form of a spherical cap with a slightly larger radius than the balls. The rims of these walls form openings with dimensions dictated by the thickness of the cage that are slightly narrower than the diameter of the balls. In this way, the balls can be inserted by force in the cavities, the rims of which deform elastically during insertion, and then be retained inside the cavities. In practice, relatively high friction is detected between the balls and the walls of the cage, which produces a resisting torque that prevents the free rotation of the bearing. This friction is so high that the manufacturing tolerances of the rings can cause some of the balls to come out of their ideal trajectory due to dimension dispersions. In particular, the centres of the balls are not necessarily all located in the same plane, perpendicular to the axis of rotation of the bearing, and some of the balls can momentarily be closer to or further from the axis of rotation of the bearing. Deviations from the ideal trajectory can also appear due to the fits and clearings and strain on the bearing.

To reduce this friction it is naturally possible to increase the radius of the cavities for a given ball diameter. However, such an increase implies increasing the thickness of the cage, to ensure the separation of the rims is less than the diameter of the balls. Such an increase is not desirable, since it increases the production cost of the cage, its mass and its moment of inertia.

### SUMMARY OF THE INVENTION

The invention therefore aims to solve the disadvantages of the prior art, so as to provide a cage configuration that considerably reduces the friction.

The invention relates, according to a first aspect, to a cage for a radial angular-contact ball bearing with a generally annular shape defining an axis of rotation of the bearing, the cage comprising a plurality of cavities designed to each accommodate a ball, wherein at least one of the cavities comprises two opposing concave walls, each of the two walls being in the shape of a spherical cap with a radius R defining a centre in which the distance to the opposite wall is greater than R, the centres of the two caps being in the same radial plane at a distance from one another, one of the centres being closer to the axis of rotation of the bearing than the other.

In a cross-section according to a plane passing through the two centres of the cavity, it has an oblong shape. The measurement of the clearance thus created is substantially equal to the distance between the two centres of the cavity. The centres of the two caps are at different distances from the axis of rotation, which allows a clearance in the radial direction, where the dimension dispersions are the most sensitive.

Preferably, the two spherical caps are connected by two faces of a cylindrical enclosure with a radius R and a height equal to the distance between the centres of the two caps. These two faces determine a slight clearance for positioning the balls in a direction tangential to the pitch circle of the bearing, which helps to maintain the balls in position.

According to one embodiment, the centres of the two caps are not in the same plane, perpendicular to the axis of rotation.

Preferably, all the cavities are shaped identically, allowing easy assembly without any positioning constraints.

The cage is advantageously made from a piece of thermoplastic material having a certain elasticity, allowing the balls to be inserted by force in the cavities.

According to a second aspect of the invention, it relates to a radial angular-contact ball bearing comprising two annular raceways with balls placed between them, the centres of which are distributed around a pitch circle of the bearing, the points of contact between the balls and the two raceways being distributed on a contact cone, as well as a cage such as previously described. The centres of the two caps are located on an axis that is substantially perpendicular to the contact cone. This makes it possible, in particular, to adapt the movements of the balls in the radial and axial directions. The diameter of the balls housed in the cavities is slightly less than 2R. Advantageously, the walls of each cavity form at least one closed rim in which the largest dimension is smaller than the diameter of the ball housed in the cavity. Advantageously, the two spherical caps of each cavity are respectively arranged on either side of a plane that is perpendicular to the axis of rotation of the bearing and contains the pitch circle, the tilted axis cutting across the pitch circle, the tilted axis intersecting the pitch circle substantially at the middle of the two centres.

### BRIEF DESCRIPTION OF THE FIGURES

Further advantages and characteristics will emerge more clearly from the following description of specific embodiments of the invention, provided as non-limiting examples, and shown in the appended drawings, wherein:

FIG. 1 shows, in an axial cross-section, a stop of a MacPherson strut according to one embodiment of the invention;

FIG. 2 shows a bearing cage used in the stop of FIG. 1.

### DETAILED DESCRIPTION OF AN EMBODIMENT

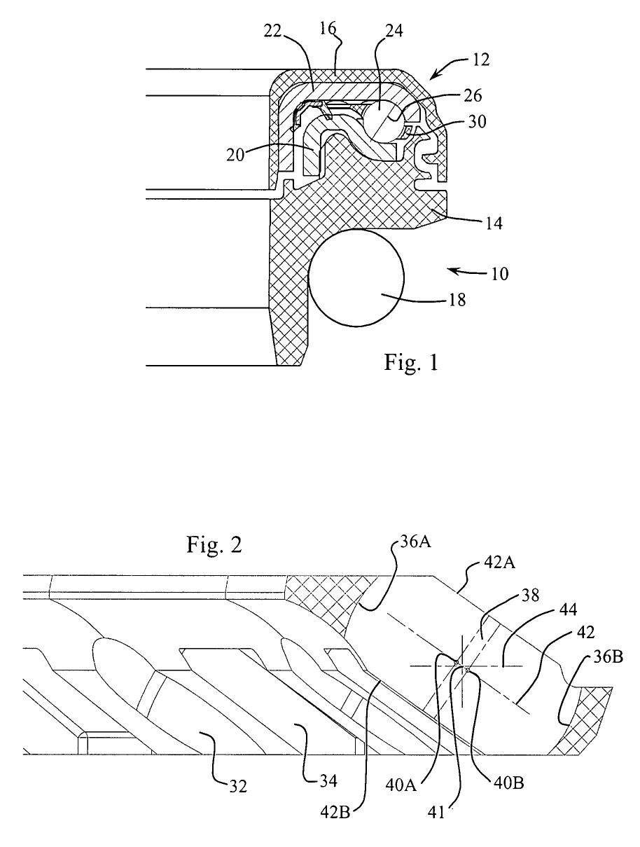

In reference to FIG. 1, a stop of a telescopic MacPherson strut 10 comprises a radial angular-contact ball bearing 12 housed between a lower mount 15 made from synthetic material and a cover 16. The lower mount 14 acts as a seat for a coil spring 18 of the MacPherson strut, while the cover 16 is directly or indirectly fixed to the superstructure of the vehicle.

The ball bearing 12 consists of a bottom washer 20 and a top washer 22, both made from pressed steel, forming radial angular-contact raceways for the balls 24. The geometry of the races is such that, with zero torque, each ball is in contact with the raceways at two points located on a contact line 26, the contact lines of the various balls furthermore being on the same contact cone. It should be noted that the washers 20, 22 that form the bearing 12 have high rigidity and are preferably made from pressed steel.

A cage 30 furthermore assures that the balls 24 are held and relatively positioned in the bearing. The cage 30, shown in detail in FIG. 2, is preferably made from a piece of thermoplastic material, for example polyamide, comprising cavities 32 that each house one ball 24 of the bearing. The cavities 32 can, as required, be separated from one another by recesses 34 that have the only function of limiting the mass and moment of inertia of the cage. Each cavity 32 is formed by two concave surfaces 36A, 36B shaped as spherical caps facing one another, connected by cylindrical connection surfaces 38.

The spherical caps 36A, 36B have the same radius R and each define a centre 40A, 40B. Remarkably, the two centres 40A, 40B thus defined for each cavity are separated from one another so as to be located at a distance from the opposite surface which is greater than the radius R. More specifically, the centres 40A, 40B are located on a geometrical axis 42 in a radial plane of the bearing, which extends perpendicular to the contact cone defined by the contact line 26. The middle 41 of the two centres 40A, 40B is preferably located on the pitch circle. Due to its construction, the axis 42 passing through the centres 40A, 40B is the same as the axis of the cylinder that constitutes the enclosure of the faces 38. The two centres 40A, 40B are located on either side of a median plane 44 of the cage, perpendicular to the axis of rotation of the bearing, which is also coplanar with the pitch circle of the bearing. A clearance corresponding to the height of the cylindrical surfaces 38 and to the distance between the centres 40A and 40B is thus created parallel to the axis 42, which allows the balls housed in the cavities to be positioned freely according to the load of the bearing and the manufacturing tolerances. In the direction tangential to the pitch circle on the contrary, the acceptable clearance remains very low and is defined only by the slight difference between the diameter of the balls and the diameter 2R of the cylinder containing the connection surfaces 38.

This arrangement considerable reduces the friction couple inside the bearing. More specifically, the degree of freedom for radial and axial positioning of the balls 24 in the cavities 32 prevents all friction at this level. The bearing is therefore relatively unaffected by load changes and manufacturing dimensional tolerances.

The caps 36A and 36B are located on either side of the median plane 44. The walls of each cavity define between them two rims 42A, 42B on either side of the plane perpendicular to the axis of rotation of the bearing and contain the pitch circle. The thickness D of the ring is such that the distance between any two points of a rim measured parallel to an axis tangential to the pitch circle is always less than the diameter of the balls. In other words, the cavity is closed enough to prevent the balls from coming loose. They are inserted by force, with elastic deformation of the walls.

Naturally, various modifications are possible without departing from the context of the invention according to the claims.

1. A cage for a radial angular-contact ball bearing with a generally annular shape defining an axis of rotation of the bearing, the cage comprising a plurality of cavities designed to each accommodate a ball, wherein at least one of the cavities comprises two opposite concave walls, each one of the two walls being in the shape of a spherical cap with a radius R and a centre located at a distance from the other one of the two opposite walls greater than R, the centres of the two opposite walls being in a common radial plane at a distance from one another, one of the centres being closer to the axis of rotation of the bearing than the other.

2. The cage of claim 1, wherein the two spherical caps are connected by two cylindrical walls having a radius R and a height equal to the distance between the centres of the two caps.

3. The cage of claim 1, wherein the centres of the two caps are not in a common plane perpendicular to the axis of rotation.

4. The cage of claim 1, wherein all the cavities are shaped identically.

5. The cage of claim 1, wherein the cage is made from a piece of thermoplastic material.

6. A radial angular-contact ball bearing comprising:
two annular raceways with
balls placed between the two raceways, the balls having centres distributed around a pitch circle of the bearing, the balls having points of contact with the two raceways, the points of contact being distributed on a common contact cone,
a cage having a generally annular shape defining an axis of rotation, the cage comprising a plurality of cavities designed to each accommodate one of the balls, wherein at least one of the cavities comprises two opposite concave walls, each one of the two walls being in the shape of a spherical cap with a radius R and a centre located at a distance from the other one of the two opposite walls greater than R, the centres of the two opposite walls being in a common radial plane at a distance from one another, one of the centres being closer to the axis of rotation of the bearing than the other.

7. The radial angular-contact ball bearing of claim 6, wherein the centres of the two caps are located on an axis that is substantially perpendicular to the contact cone.

8. The radial angular-contact ball bearing of claim 6, wherein the walls of each cavity form at least one closed rim, the largest dimension of the rim being smaller than the diameter of the ball housed in the cavity.

9. The radial angular-contact ball bearing of claim 6, wherein the centres of the two caps are located on an axis that cuts across the pitch circle.

10. The radial angular-contact ball bearing of claim 9, wherein the middle of the two centres is located on the pitch circle.
